(19) United States
(12) Patent Application Publication
(10) Pub. No.: US 2017/0193212 A1
(43) Pub. Date: Jul. 6, 2017

(54) Screen Interface Unlocking Method And Screen Interface Unlocking Device

(71) Applicant: Yulong Computer Telecommunication Scientific (Shenzhen) Co., Ltd., Shenzhen, Guangdong (CN)

(72) Inventors: Jiacheng Lai, Shenzhen, Guangdong (CN); Gang Yuan, Shenzhen, Guangdong (CN); Liliang Zheng, Shenzhen, Guangdong (CN)

(21) Appl. No.: 15/320,626

(22) PCT Filed: Feb. 28, 2015
(86) PCT No.: PCT/CN2015/073443

§ 371 Date: Dec. 20, 2016

(30) Foreign Application Priority Data
Jan. 9, 2015 (CN) 201510012126.5

(51) Int. Cl. G06F 21/32; G06F 21/60; G06F 3/16

(52) U.S. Cl. CPC G06F 21/32; G06F 3/167; G06F 21/602; G06F 3/0488

(57) ABSTRACT

Disclosed herein are a screen interface unlocking method, a screen interface unlocking device, and a terminal. The screen interface unlocking method includes: when a terminal receives a screen interface wake-up instruction, receiving a screen interface unlocking key input by a user and collecting voice information input by the user; when the screen interface unlocking key matches a preset target screen interface decryption key and the voice information matches preset target voice information, controlling the terminal to enter a first operating system; and when the screen interface unlocking key matches the preset target screen interface decryption key and the voice information does not matches the preset target voice information, controlling the terminal to enter a second operating system.

### CROSS REFERENCE TO RELATED APPLICATIONS

This present application claims the benefit of priority to China Patent Application No. 201510012126.5, filed in Chinese Patent Office on Jan. 9, 2015, and entitled “SCREEN INTERFACE UNLOCKING METHOD AND SCREEN INTERFACE UNLOCKING DEVICE”, the content of which is hereby incorporated by reference in its entirety.

### FIELD OF THE INVENTION

The present invention relates to the field of communication technology, and more particularly, to a screen interface unlocking method and a screen interface unlocking device.

### BACKGROUND OF THE INVENTION

Along with the rapid promotion of processing capacity of computers, the technology of protecting the safety of mobile phones has been fast developed, and user operations are becoming increasingly diverse. At present, a double-system unlocking solution of a terminal such as the mobile phone focuses on how to unlock to ensure the safety of the mobile phone of a user.

In the existing technical solution, in the case of a mobile phone stolen, when the mobile phone is awakened, the mobile phone will show a double-system unlocking interface. That is, the mobile phone showing the double-system unlocking interface is equivalent to tell others who stole the mobile phone that the mobile phone has important personal information, which may reduce the security of the mobile phone.

Therefore, a new kind of technical solution is needed, which can increase the concealment and the security of a secure system in a double-system terminal so as to avoid leakage of privacy data in the secure system.

### SUMMARY OF THE INVENTION

To solve the above problems, the present disclosure aims to provide a new kind of technical solution, which can increase the concealment and the security of a secure system in a double-system terminal so as to avoid leakage of privacy data in the secure system.

According to one aspect of the present disclosure, a screen interface unlocking method is applied to a terminal, the terminal includes a first operating system and a second operating system, wherein the security level of the first operating system is higher than the security level of the second operating system; the screen interface unlocking method includes: receiving a screen interface unlocking key input by a user and collecting voice information input by the user when the terminal receives a screen interface wake-up instruction; controlling the terminal to enter the first operating system when the screen interface unlocking key matches a preset target screen interface decryption key and the voice information matches preset target voice information; controlling the terminal to enter the second operating system when the screen interface unlocking key matches the preset target screen interface decryption key and the voice information does not match the preset target voice information.

In the technical solution, during the process of screen unlocking, speech recognition is specially added and used to unlock the screen of the terminal such as a mobile phone, that is, the terminal receives a screen interface unlocking key input by a user and verifies the screen interface unlocking key, and at the same time the terminal acquires voice information input by the user, then it is determined whether to allow the user to access corresponding operating systems according to the screen interface unlocking key and the voice information. Specifically, when both the screen interface unlocking key and the voice information are successfully verified, the user is allowed to access the first operating system, namely, when the screen interface unlocking key is matched with a preset target screen interface decryption key and the voice information is matched with preset target voice information, then the user is allowed to access the first operating system; when only the screen interface unlocking key is successfully verified, the user is only allowed to access the second operating system, that is, when the screen interface unlocking key is matched with the preset target screen interface decryption key but the voice information is not matched with the preset target voice information, then the user is only allowed to enter the second operating system. In detail, the first operating system can be a secure system in a double-system terminal, and the second operating system can be a common system in the double-system terminal. In this way, based on the two-factor authentication, the concealment and security of the secure system in the double-system terminal can be increased to avoid leakage of privacy data in the secure system and improve the user experience.

In the above technical solution, preferably, the way of screen unlocking includes, but not limited to, a voice unlocking mode and a touch unlocking mode. The step of receiving a screen interface unlocking key input by a user and collecting voice information input by the user when a terminal receives a screen interface wake-up instruction specifically includes: judging a present way of screen unlocking of the terminal when the terminal receives the screen interface wake-up instruction; prompting the user to input screen unlocking passwords corresponding to the touch unlocking mode when the present way of screen unlocking is the touch unlocking mode; and receiving the screen unlocking passwords input by the user and acquiring the voice information input by the user; further includes: matching the screen unlocking passwords with the preset target screen interface decryption key, and analyzing the voice information to generate voiceprint data, and matching the voiceprint data with preset voiceprint data; determining that the voice information is matched with the preset target voice information when the voiceprint data is matched with the preset voiceprint data.

In the technical solution, there are many ways of unlocking screen of the terminal, such as the voice unlocking mode and the touch unlocking mode. When the present way of screen unlocking is the touch unlocking mode, the terminal receives a touch operation input by the user and acquires the voice information input by the user at the same time, and verifies the touch operation and the voice information at the same time, only the touch operation and the voice information are successfully verified, namely, only the voice information and the touch operation pass their verification steps, the terminal can access the first operating system, namely the secure system; when only the touch operation passes its verification step, then the terminal can access the second operation system, namely the common system. In detail, a verification method of voice information at least includes: analyzing the voice information to generate corresponding voiceprint data, and comparing the voiceprint data with the preset voiceprint data. Since the voiceprint data can reflect voice features of a user, namely, the voiceprint data can be used to represent voice features of a user, as a result, an owner of the terminal can input and store preset voiceprint data in the terminal, therefore, as long as the voiceprint data acquired by the terminal is matched with the preset voiceprint data, that means the user is the owner himself, at this time, the user is allowed to enter the secure system, otherwise not allowed to enter the secure system, so as to ensure the security of personal information and user data in the secure system.

In the above technical solution, preferably, the step of receiving a screen interface unlocking key input by a user and collecting voice information input by the user when a terminal receives a screen interface wake-up instruction further includes: directly acquiring the voice information input by the user and taking the voice information as the screen unlocking passwords when the present way of screen unlocking is the voice unlocking mode; and analyzing the voice information to generate corresponding voiceprint data, and matching the voiceprint data with the preset voiceprint data; determining that the screen interface unlocking key is matched with the preset target screen interface unlocking key when the voiceprint data is matched with the preset voiceprint data; determining whether the voice information includes preset keywords when the voiceprint data is matched with the preset voiceprint data; and determining that the voice information is matched with the preset target voice information when the voice information includes the preset keywords.

In the technical solution, when the present way of screen unlocking is the voice unlocking mode, the terminal directly acquires the voice information input by the user and analyzes the voice information to generate corresponding voiceprint data, so when the voiceprint data acquired by the terminal is matched with the preset voiceprint data input by the owner of the terminal, that means the user is the owner himself, at this time, the user is allowed to enter the common system. Furthermore, the terminal determines whether the voice information includes preset keywords, when the voice information includes the preset keywords, then the user is allowed to access the secure system. Thus, the user does not need to unlock the terminal by means of touch unlocking and does not have to input the screen unlocking passwords on the screen of the terminal, the terminal can access the secure system as long as the user says the keywords, which can not only avoid tedious touch operations, but also can ensure the security of personal information and user data in the secure system and improve the user experience.

In the above technical solution, preferably, the screen interface unlocking method further includes: setting the target screen interface unlocking key, the preset voiceprint data and/or the preset keywords according to received setting commands.

In the technical solution, because double unlocking information such as the preset voiceprint data and the preset keywords are set, therefore the security of the secure system and the concealment of the unlocking information can be better safeguarded. That is, the way of setting the preset voiceprint data and the preset keywords can better safeguard the concealment of the unlocking information and the security of the secure system.

In the above technical solution, preferably, the screen interface unlocking method further includes: prompting the user that unlocking fails when the screen interface unlocking key is not matched with the preset target screen interface decryption key and the voice information is not matched with the preset target voice information; outputting an alarm prompt when the number of failed to unlock the screen reaches a preset number in succession.

In this technical solution, when the screen interface unlocking key and the voice information fail to validation process, namely, the screen interface unlocking key is not matched with the preset target screen interface decryption key and the voice information is not matched with the preset target voice information, and the number of failed to unlock the screen reaches the preset number in succession, which can ensure the safety of the terminal. Specifically, the method of outputting an alarm prompt includes, but not limited to, locking the terminal, sending information to at least one related terminal, sending GPS (Global Position System) information to the at least one related terminal, etc.

According to another aspect of the present disclosure, a screen interface unlocking device provided by the present disclosure is applied to a terminal, and the terminal includes a first operating system and a second operating system, wherein the security level of the first operating system is higher than the security level of the second operating system; the screen interface unlocking device includes: an acquiring unit configured for receiving a screen interface unlocking key input by a user and collecting voice information input by the user when the terminal receives a screen interface wake-up instruction; a controlling unit configured for controlling the terminal to enter the first operating system when the screen interface unlocking key matches a preset target screen interface decryption key and the voice information matches preset target voice information; and controlling the terminal to enter the second operating system when the screen interface unlocking key matches the preset target screen interface decryption key and the voice information does not match the preset target voice information.

In the technical solution, during the process of screen unlocking, speech recognition is specially added and used to unlock the screen of the terminal, that is, the terminal receives a screen interface unlocking key input by a user and verifies the screen interface unlocking key, and at the same time the terminal acquires voice information input by the user, then it is determined whether to allow the user to access corresponding operating systems according to the screen interface unlocking key and the voice information. Specifically, when both the screen interface unlocking key and the voice information are successfully verified, the user is allowed to access the first operating system, namely, when the screen interface unlocking key is matched with the preset target screen interface decryption key and the voice information is matched with the preset target voice information, then the user is allowed to access the first operating system; when only the screen interface unlocking key is successfully verified, the user is only allowed to access the second operating system, that is, when the screen interface unlocking key is matched with the preset target screen interface decryption key but the voice information is not matched with the preset target voice information, then the user is only allowed to enter the second operating system. In detail, the first operating system can be a secure system in a double-system terminal, and the second operating system can be a common system in the double-system terminal. In this way, based on the two-factor authentication, the concealment and security of the secure system in the double-system terminal can be increased so as to avoid leakage of privacy data in the secure system and improve the user experience.

In the above technical solution, preferably, the way of screen unlocking includes, but not limited to, a voice unlocking mode and a touch unlocking mode. The acquiring unit includes a judging module, a first prompting module and an acquiring module. The judging module is configured for judging a present way of screen unlocking of the terminal when the terminal receives the screen interface wake-up instruction; the first prompting module is configured for prompting the user to input screen unlocking passwords corresponding to the touch unlocking mode when the present way of screen unlocking is the touch unlocking mode; the acquiring module is configured for receiving the screen unlocking passwords input by the user and acquiring the voice information input by the user. The screen interface unlocking device further includes a matching unit configured for matching the screen unlocking passwords with the preset target screen interface decryption key, and analyzing the voice information to generate voiceprint data, and matching the voiceprint data with preset voiceprint data; and a determining unit configured for determining that the voice information is matched with the preset target voice information when the voiceprint data is matched with the preset voiceprint data.

In the technical solution, there are many ways of unlocking screen of the terminal, such as the voice unlocking mode and the touch unlocking mode. When the present way of screen unlocking is the touch unlocking mode, the terminal receives a touch operation input by the user and acquires the voice information input by the user at the same time, and verifies the touch operation and the voice information at the same time, only the touch operation and the voice information are successfully verified, namely, only the voice information and the touch operation pass their verification steps, the terminal can access the first operating system, namely the secure system; when only the touch operation is successfully verified, namely, only the touch operation passes its verification step, then the terminal can access the second operation system, namely the common system. In detail, the way of verifying the voice information at least includes: analyzing the voice information to generate corresponding voiceprint data, and comparing the voiceprint data with the preset voiceprint data. Since the voiceprint data can reflect voice features of a user, namely, the voiceprint data can be used to represent voice features of a user, as a result, an owner of the terminal can input and store preset voiceprint data in the terminal, therefore, as long as the voiceprint data acquired by the terminal is matched with the preset voiceprint data, that means the user is the owner himself, at this time, the user is allowed to enter the secure system, otherwise not allowed to enter the secure system, so as to ensure the security of personal information and user data in the secure system.

In the above technical solution, preferably, the acquiring module is further configured for directly acquiring the voice information input by the user and taking the voice information as the screen unlocking passwords when the present way of screen unlocking is the voice unlocking mode. The matching unit is further configured for analyzing the voice information to generate corresponding voiceprint data, and matching the voiceprint data with the preset voiceprint data. The determining unit is further configured for determining that the screen interface unlocking key is matched with the preset target screen interface unlocking key when the voiceprint data is matched with the preset voiceprint data, and determining whether the voice information includes preset keywords when the voiceprint data is matched with the preset voiceprint data, and determining that the voice information is matched with the preset target voice information when the voice information includes the preset keywords.

In the technical solution, when the present way of screen unlocking is the voice unlocking mode, the terminal directly acquires the voice information input by the user and analyzes the voice information to generate corresponding voiceprint data, so when the voiceprint data acquired by the terminal is matched with the preset voiceprint data input by the owner of the terminal, that means the user is the owner himself, at this time, the user is allowed to enter the common system. Furthermore, the terminal determines whether the voice information includes preset keywords, when the voice information includes the preset keywords, then the user is allowed to access the secure system. Thus, the user does not need to unlock the terminal by means of touch unlocking and does not have to input the screen unlocking passwords on the screen of the terminal, the terminal can access the secure system as long as the user says the keywords, which can not only avoid tedious touch operations, but also can ensure the security of personal information and user data in the secure system and improve the user experience.

In the above technical solution, preferably, the screen interface unlocking device further includes a setting unit configured for setting the target screen interface unlocking key, the preset voiceprint data and/or the preset keywords according to received setting commands.

In the technical solution, because double unlocking information such as the preset voiceprint data and the preset keywords are set, therefore the security of the secure system and the concealment of the unlocking information can be better safeguarded. That is, the way of setting the preset voiceprint data and the preset keywords can better safeguard the concealment of the unlocking information and the security of the secure system.

In the above technical solution, preferably, the screen interface unlocking device further includes a second prompting unit and an alarming unit. The second prompting unit is configured for prompting the user that unlocking fails when the screen interface unlocking key is not matched with the preset target screen interface decryption key and the voice information is not matched with the preset target voice information. The alarming unit is configured for outputting an alarm prompt when the number of failed to unlock the screen reaches a preset number in succession.

In this technical solution, when the screen interface unlocking key and the voice information fail toe validation process, namely, the screen interface unlocking key is not matched with the preset target screen interface decryption key and the voice information is not matched with the preset target voice information, and the number of failed to unlock the screen reaches the preset number in succession, which can ensure the safety of the terminal. Specifically, the method of outputting an alarm prompt includes, but not limited to, locking the terminal, sending information to at least one related terminal, sending GPS (Global Position System) information to the at least one related terminal, etc.

According to another aspect of the present disclosure, a terminal is provided, and the terminal includes: at least one input device, at least one output, at least one processor, a memory and a at least one bus, wherein,

the bus is used to connect the input device, the output device, the at least one processor and the memory;

the input device is used to receive a screen interface unlocking key and acquire voice information input by a user when receiving a screen interface wake-up instruction;

the memory stores a group of grogram codes or computer programs for implementing processes, and the processor calls and reads the grogram codes or computer programs stored in the memory to execute the following operations:

controlling the terminal to enter a first operating system when the screen interface unlocking key is matched with a preset target screen interface decryption key and the voice information is matched with preset target voice information;

controlling the terminal to enter a second operating system when the screen interface unlocking key is matched with the preset target screen interface decryption key and the voice information is not matched with the preset target voice information; wherein, the security level of the first operating system is higher than the security level of the second operating system.

In the above technical solution, preferably, the way of screen unlocking includes, but not limited to, a voice unlocking mode and a touch unlocking mode; when receiving the screen interface wake-up instruction, the input device receives the screen interface unlocking key input by the user and acquires the voice information input by the user, which includes that in detail:

the processor determines a present way of screen unlocking of the terminal when the input device receives the screen interface wake-up instruction;

the output device prompts the user to input screen unlocking passwords corresponding to the touch unlocking mode when the present way of screen unlocking is the touch unlocking mode;

the input device receives the screen unlocking passwords input by the user and acquires the voice information input by the user; and

further includes:

the processor matches the screen unlocking passwords with the preset target screen interface decryption key, and analyzes the voice information to generate voiceprint data, and matches the voiceprint data with preset voiceprint data;

the processor determines that the voice information is matched with the preset target voice information when the voiceprint data is matched with the preset voiceprint data.

In the above technical solution, preferably, after the processor determines a present way of screen unlocking of the terminal, the input device, the output device and the processor can execute the following operations:

the input device directly acquires the voice information input by the user and takes the voice information as the screen unlocking passwords when the present way of screen unlocking is the voice unlocking mode;

the processor analyzes the voice information to generate corresponding voiceprint data, and matches the voiceprint data with the preset voiceprint data;

the processor determines that the screen interface unlocking key is matched with the preset target screen interface unlocking key when the voiceprint data is matched with the preset voiceprint data;

the processor determines whether the voice information includes preset keywords when the voiceprint data is matched with the preset voiceprint data; and

the processor determines that the voice information is matched with the preset target voice information when the voice information includes the preset keywords.

In the above technical solution, preferably, the processor sets the target screen interface unlocking key, the preset voiceprint data and/or the preset keywords according to received setting commands.

In the above technical solution, preferably, the output device prompts the user that unlocking fails when the screen interface unlocking key is not matched with the preset target screen interface decryption key and the voice information is not matched with the preset target voice information; and

the output device outputs an alarm prompt when the number of failed to unlock the screen reaches a preset number in succession.

By means of the technical solution of the present invention, the concealment and the security of a secure system in a double-system terminal can be improved, thereby avoiding leakage of privacy data in the secure system.

### BRIEF DESCRIPTION OF THE DRAWINGS

FIG. 1 is a flowchart of a screen interface unlocking method according to an embodiment of the present disclosure;

FIG. 2 is a block diagram of a screen interface unlocking device according to an embodiment of the present disclosure;

FIG. 3 is a detailed flowchart of a screen interface unlocking method according to an embodiment of the present disclosure;

FIG. 4 is a detailed flowchart of a screen interface unlocking method according to another embodiment of the present disclosure;

FIG. 5 is a detailed flowchart of a screen interface unlocking method according to yet another embodiment of the present disclosure; and

FIG. 6 is a block diagram of a terminal according to an embodiment of the present disclosure.

### DETAILED DESCRIPTION OF ILLUSTRATED EMBODIMENTS

In order to illustrate the embodiments or existing technical solutions more clearly, a brief description of drawings that assists the description of embodiments of present disclosure or existing art will be provided below. It should be noted that, in the case of no conflict, the embodiments of the present disclosure and the features of each embodiment can be combined mutually.

The invention will now be described in detail on the basis of preferred embodiments and drawings. It is to be understood that various changes may be made without departing from the spirit and scope of the disclosure and the embodiments of the present disclosure and features in the embodiments can be combined with each other.

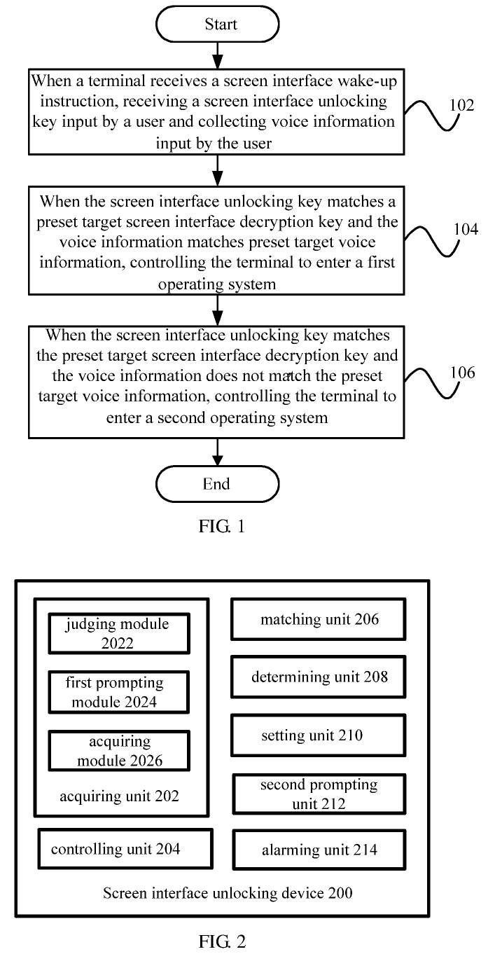

Referring to FIG. 1, FIG. 1 is a flowchart of a screen interface unlocking method according to an embodiment of the present disclosure.

As shown in FIG. 1, a screen interface unlocking method provided by the embodiment of the present disclosure includes: step 102, receiving a screen interface unlocking key input by a user and collecting voice information input by the user when a terminal receives a screen interface wake-up instruction; step 104, controlling the terminal to enter a first operating system when the screen interface unlocking key matches a preset target screen interface decryption key and the voice information matches preset target voice information; and step 106, controlling the terminal to enter a second operating system when the screen interface unlocking key matches the preset target screen interface decryption key and the voice information does not match the preset target voice information.

In the technical solution, during the process of screen unlocking, speech recognition is specially added and used to unlock the screen of the terminal such as a mobile phone, that is, the terminal receives a screen interface unlocking key input by a user and verifies the screen interface unlocking key, and at the same time the terminal acquires voice information input by the user, then it is determined whether to allow the user to access corresponding operating systems according to the screen interface unlocking key and the voice information. Specifically, when both the screen interface unlocking key and the voice information are successfully verified, the user is allowed to access the first operating system, namely, when the screen interface unlocking key is matched with a preset target screen interface decryption key and the voice information is matched with preset target voice information, then the user is allowed to access the first operating system; when only the screen interface unlocking key is successfully verified, the user is only allowed to access the second operating system, that is, when the screen interface unlocking key is matched with the preset target screen interface decryption key but the voice information is not matched with the preset target voice information, then the user is only allowed to enter the second operating system. In detail, the first operating system can be a secure system in a double-system terminal, and the second operating system can be a common system in the double-system terminal. In this way, based on the two-factor authentication, the concealment and the security of the secure system in the double-system terminal can be increased to avoid leakage of privacy data in the secure system and improve the user experience.

In the above technical solution, preferably, the way of screen unlocking includes, but not limited to, a voice unlocking mode and a touch unlocking mode. The step of receiving a screen interface unlocking key input by a user and collecting voice information input by the user when a terminal receives a screen interface wake-up instruction specifically includes: judging a present way of screen unlocking of the terminal when the terminal receives the screen interface wake-up instruction; prompting the user to input screen unlocking passwords corresponding to the touch unlocking mode when the present way of screen unlocking is the touch unlocking mode; and receiving the screen unlocking passwords input by the user and acquiring the voice information input by the user; further includes: matching the screen unlocking passwords with the preset target screen interface decryption key, and analyzing the voice information to generate voiceprint data, and matching the voiceprint data with preset voiceprint data; determining that the voice information is matched with the preset target voice information when the voiceprint data is matched with the preset voiceprint data.

In the technical solution, there are many ways of unlocking screen of the terminal, such as the voice unlocking mode and the touch unlocking mode. When the present way of screen unlocking is the touch unlocking mode, the terminal receives a touch operation input by the user and acquires the voice information input by the user at the same time, and verifies the touch operation and the voice information at the same time, only the touch operation and the voice information are successfully verified, namely, only the voice information and the touch operation pass their verification steps, the terminal can access the first operating system, namely the secure system; when only the touch operation passes its verification step, then the terminal can access the second operation system, namely the common system. In detail, a verification method of voice information at least includes: analyzing the voice information to generate corresponding voiceprint data, and comparing the voiceprint data with the preset voiceprint data. Since the voiceprint data can reflect voice features of a user, namely, the voiceprint data can be used to represent voice features of a user, as a result, an owner of the terminal can input and store preset voiceprint data in the terminal, therefore, as long as the voiceprint data acquired by the terminal is matched with the preset voiceprint data, that means the user is the owner himself, at this time, the user is allowed to enter the secure system, otherwise not allowed to enter the secure system, so as to ensure the security of personal information and user data in the secure system.

In the above technical solution, preferably, the step of receiving a screen interface unlocking key input by a user and collecting voice information input by the user when a terminal receives a screen interface wake-up instruction further includes: directly acquiring the voice information input by the user and taking the voice information as the screen unlocking passwords when the present way of screen unlocking is the voice unlocking mode; and analyzing the voice information to generate corresponding voiceprint data, and matching the voiceprint data with the preset voiceprint data; determining that the screen interface unlocking key is matched with the preset target screen interface unlocking key when the voiceprint data is matched with the preset voiceprint data; determining whether the voice information includes preset keywords when the voiceprint data is matched with the preset voiceprint data; and determining that the voice information is matched with the preset target voice information when the voice information includes the preset keywords.

In the technical solution, when the present way of screen unlocking is the voice unlocking mode, the terminal directly acquires the voice information input by the user and analyzes the voice information to generate corresponding voiceprint data, so when the voiceprint data acquired by the terminal is matched with the preset voiceprint data input by the owner of the terminal, that means the user is the owner himself, at this time, the user is allowed to enter the common system. Furthermore, the terminal determines whether the voice information includes preset keywords, when the voice information includes the preset keywords, then the user is allowed to access the secure system. Thus, the user does not need to unlock the terminal by means of touch unlocking and does not have to input the screen unlocking passwords on the screen of the terminal, the terminal can access the secure system as long as the user says the keywords, which can not only avoid tedious touch operations, but also can ensure the security of personal information and user data in the secure system and improve the user experience.

In the above technical solution, preferably, the screen interface unlocking method further includes: setting the target screen interface unlocking key, the preset voiceprint data and/or the preset keywords according to received setting commands.

In the technical solution, because double unlocking information such as the preset voiceprint data and the preset keywords are set, therefore the security of the secure system and the concealment of the unlocking information can be better safeguarded. That is, the way of setting the preset voiceprint data and the preset keywords can better safeguard the concealment of the unlocking information and the security of the secure system.

In the above technical solution, preferably, the screen interface unlocking method further includes: prompting the user that unlocking fails when the screen interface unlocking key is not matched with the preset target screen interface decryption key and the voice information is not matched with the preset target voice information; outputting an alarm prompt when the number of failed to unlock the screen reaches a preset number in succession.

In this technical solution, when the screen interface unlocking key and the voice information fail to validation process, namely, the screen interface unlocking key is not matched with the preset target screen interface decryption key and the voice information is not matched with the preset target voice information, and the number of failed to unlock the screen reaches the preset number in succession, which can ensure the safety of the terminal. Specifically, the method of outputting an alarm prompt includes, but not limited to, locking the terminal, sending information to at least one related terminal, sending GPS (Global Position System) information to the at least one related terminal, etc.

Referring to FIG. 2, FIG. 2 is a block diagram of a screen interface unlocking device according to an embodiment of the present disclosure.

As shown in FIG. 2, a screen interface unlocking device 200 provided by this embodiment of the present disclosure is applied to a terminal such as a mobile phone. The terminal includes a first operating system and a second operating system, wherein the security level of the first operating system is higher than the security level of the second operating system. The screen interface unlocking device 200 includes: an acquiring unit 202 and a controlling unit 204. The acquiring unit 202 is configured for receiving a screen interface unlocking key input by a user and collecting voice information input by the user when the terminal receives a screen interface wake-up instruction. The controlling unit 204 is configured for controlling the terminal to enter the first operating system when the screen interface unlocking key matches a preset target screen interface decryption key and the voice information matches preset target voice information; and controlling the terminal to enter the second operating system when the screen interface unlocking key matches the preset target screen interface decryption key and the voice information does not match the preset target voice information.

In the technical solution, during the process of screen unlocking, speech recognition is specially added and used to unlock the screen of the terminal, that is, the terminal receives a screen interface unlocking key input by a user and verifies the screen interface unlocking key, and at the same time the terminal acquires voice information input by the user, then it is determined whether to allow the user to access corresponding operating systems according to the screen interface unlocking key and the voice information. Specifically, when both the screen interface unlocking key and the voice information are successfully verified, the user is allowed to access the first operating system, namely, when the screen interface unlocking key is matched with the preset target screen interface decryption key and the voice information is matched with the preset target voice information, then the user is allowed to access the first operating system; when only the screen interface unlocking key is successfully verified, the user is only allowed to access the second operating system, that is, when the screen interface unlocking key is matched with the preset target screen interface decryption key but the voice information is not matched with the preset target voice information, then the user is only allowed to enter the second operating system. In detail, the first operating system can be a secure system in a double-system terminal, and the second operating system can be a common system in the double-system terminal. In this way, based on the two-factor authentication, the concealment and the security of the secure system in the double-system terminal can be improved so as to avoid leakage of privacy data in the secure system and improve the user experience.

In the above technical solution, preferably, the way of screen unlocking includes, but not limited to, a voice unlocking mode and a touch unlocking mode. The acquiring unit 202 includes a judging module 2022, a first prompting module 2024 and an acquiring module 2026. The judging module 2022 is configured for judging a present way of screen unlocking of the terminal when the terminal receives the screen interface wake-up instruction; the first prompting module 2024 is configured for prompting the user to input screen unlocking passwords corresponding to the touch unlocking mode when the present way of screen unlocking is the touch unlocking mode; the acquiring module 2026 is configured for receiving the screen unlocking passwords input by the user and acquiring the voice information input by the user. The screen interface unlocking device 200 further includes a matching unit 206 configured for matching the screen unlocking passwords with the preset target screen interface decryption key, and analyzing the voice information to generate voiceprint data, and matching the voiceprint data with preset voiceprint data; and a determining unit 208 configured for determining that the voice information is matched with the preset target voice information when the voiceprint data is matched with the preset voiceprint data.

In the technical solution, there are many ways of unlocking screen of the terminal, such as the voice unlocking mode and the touch unlocking mode. When the present way of screen unlocking is the touch unlocking mode, the terminal receives a touch operation input by the user and acquires the voice information input by the user at the same time, and verifies the touch operation and the voice information at the same time, only the touch operation and the voice information are successfully verified, namely, only the voice information and the touch operation pass their verification steps, the terminal can access the first operating system, namely the secure system; when only the touch operation is successfully verified, namely, only the touch operation passes its verification step, then the terminal can access the second operation system, namely the common system. In detail, the way of verifying the voice information at least includes: analyzing the voice information to generate corresponding voiceprint data, and comparing the voiceprint data with the preset voiceprint data. Since the voiceprint data can reflect voice features of a user, namely, the voiceprint data can be used to represent voice features of a user, as a result, an owner of the terminal can input and store preset voiceprint data in the terminal, therefore, as long as the voiceprint data acquired by the terminal is matched with the preset voiceprint data, that means the user is the owner himself, at this time, the user is allowed to enter the secure system, otherwise not allowed to enter the secure system, so as to ensure the security of personal information and user data in the secure system.

In the above technical solution, preferably, the acquiring module 2026 is further configured for directly acquiring the voice information input by the user and taking the voice information as the screen unlocking passwords when the present way of screen unlocking is the voice unlocking mode. The matching unit 206 is further configured for analyzing the voice information to generate corresponding voiceprint data, and matching the voiceprint data with the preset voiceprint data. The determining unit 208 is further configured for determining that the screen interface unlocking key is matched with the preset target screen interface unlocking key when the voiceprint data is matched with the preset voiceprint data, and determining whether the voice information includes preset keywords when the voiceprint data is matched with the preset voiceprint data, and determining that the voice information is matched with the preset target voice information when the voice information includes the preset keywords.

In the technical solution, when the present way of screen unlocking is the voice unlocking mode, the terminal directly acquires the voice information input by the user and analyzes the voice information to generate corresponding voiceprint data, so when the voiceprint data acquired by the terminal is matched with the preset voiceprint data input by the owner of the terminal, that means the user is the owner himself, at this time, the user is allowed to enter the common system. Furthermore, the terminal determines whether the voice information includes preset keywords, when the voice information includes the preset keywords, then the user is allowed to access the secure system. Thus, the user does not need to unlock the terminal by means of touch unlocking and does not have to input the screen unlocking passwords on the screen of the terminal, the terminal can access the secure system as long as the user says the keywords, which can not only avoid tedious touch operations, but also can ensure the security of personal information and user data in the secure system and improve the user experience.

In the above technical solution, preferably, the screen interface unlocking device 200 further includes a setting unit 210 configured for setting the target screen interface unlocking key, the preset voiceprint data and/or the preset keywords according to received setting commands.

In the technical solution, because double unlocking information such as the preset voiceprint data and the preset keywords are set, therefore the security of the secure system and the concealment of the unlocking information can be better safeguarded. That is, the way of setting the preset voiceprint data and the preset keywords can better safeguard the concealment of the unlocking information and the security of the secure system.

In the above technical solution, preferably, the screen interface unlocking device 200 further includes a second prompting unit 212 and an alarming unit 214. The second prompting unit 212 is configured for prompting the user that unlocking fails when the screen interface unlocking key is not matched with the preset target screen interface decryption key and the voice information is not matched with the preset target voice information. The alarming unit 214 is configured for outputting an alarm prompt when the number of failed to unlock the screen reaches a preset number in succession.

In this technical solution, when the screen interface unlocking key and the voice information fail toe validation process, namely, the screen interface unlocking key is not matched with the preset target screen interface decryption key and the voice information is not matched with the preset target voice information, and the number of failed to unlock the screen reaches the preset number in succession, which can ensure the safety of the terminal. Specifically, the method of outputting an alarm prompt includes, but not limited to, locking the terminal, sending information to at least one related terminal, sending GPS (Global Position System) information to the at least one related terminal, etc.

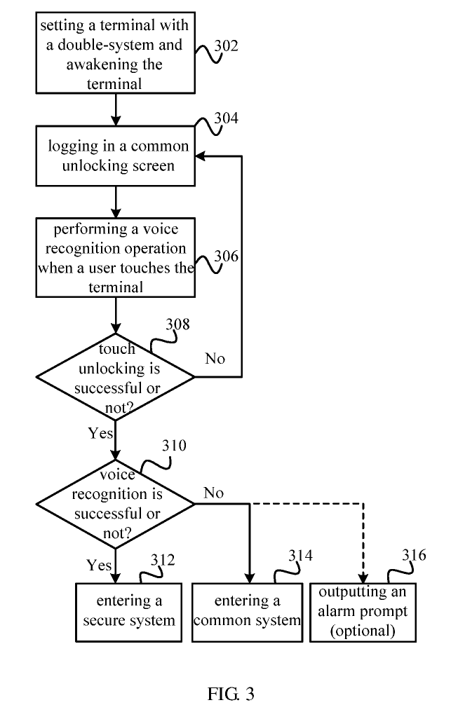

Referring to FIG. 3, FIG. 3 is a detailed flowchart of a screen interface unlocking method according to an embodiment of the present disclosure. As shown in FIG. 3, the screen interface unlocking method provided by the embodiment of the present disclosure includes at least the following steps.

Step 302, setting a terminal with a double-system and awakening the terminal to activate the double-system.

Step 304, logging in a common unlocking screen and performing a touch unlocking operation.

Step 306, performing a voice recognition operation when a user touches a screen of the terminal. In detail, after activating the double-system, a prompt of “enter preset voice data” will pop up, and according to an unlocking mode chose by the user, one or more voice recognition operations need be input in the terminal and sliding unlock/pattern unlock data need be preset in the terminal.

Step 308, determining whether a screen interface unlocking key (namely, a sliding/pattern) input by the user is matched with a preset screen interface unlocking key or not. When the screen interface unlocking key is matched with the preset screen interface unlocking key, performing step 310; when the screen interface unlocking key isn't matched with the preset screen interface unlocking key, returning to the step 304.

Step 310, determining whether the voice recognition operation is matched with preset voice recognition data or not. When the voice recognition operation is matched with the preset voice recognition data, performing step 312; when the voice recognition operation is not matched with preset voice recognition data, performing step 314 or step 316. In detail, a verification method of voice information at least includes: analyzing the voice information to generate corresponding voiceprint data, and comparing the voiceprint data with the preset voiceprint data. Since the voiceprint data can reflect voice features of a user, namely, the voiceprint data can be used to represent voice features of a user, as a result, an owner of the terminal can input and store preset voiceprint data in the terminal, therefore, as long as the voiceprint data acquired by the terminal is matched with the preset voiceprint data, that means the user is the owner himself, at this time, the user is allowed to enter the secure system, otherwise not allowed to enter the secure system, so as to ensure the security of personal information and user data in the secure system.

Step 312, entering a secure system of the terminal.

Step 314, entering a common system of the terminal.

Step 316, outputting an alarm prompt when one or more unlocking operations fail. Specifically, the method of outputting an alarm prompt includes, but not limited to, locking the terminal, sending information to at least one related terminal, sending GPS (Global Position System) information to the at least one related terminal, etc.

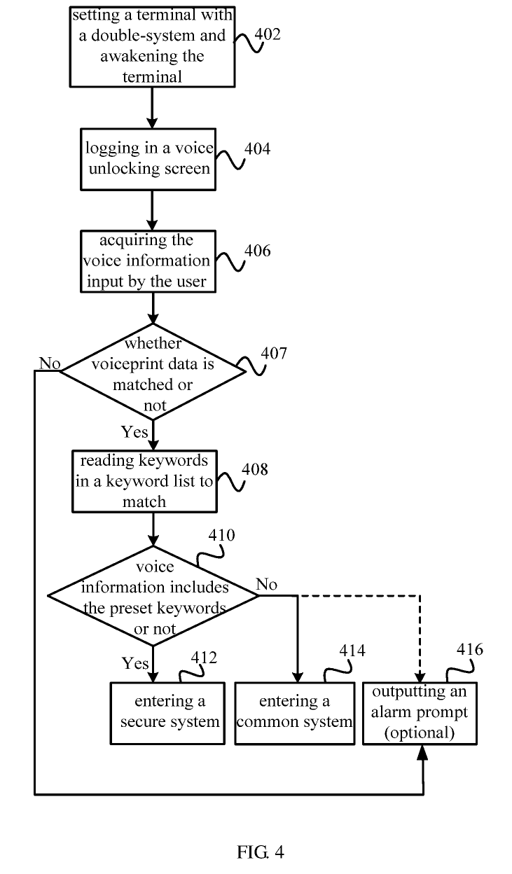

Referring to FIG. 4, FIG. 4 is a detailed flowchart of a screen interface unlocking method according to another embodiment of the present disclosure.

As shown in FIG. 4, the screen interface unlocking method provided by the embodiment of the present disclosure includes at least the following steps.

Step 402, setting a terminal with a double-system and awakening the terminal to activate the double-system. Specifically, one or more keywords for voice recognition can be preset in the terminal.

Step 404, logging in a voice unlocking screen and input voice information input by a user.

Step 406, acquiring the voice information input by the user to unlock the terminal.

Step 407, analyzing the voice information to generate voiceprint data and comparing the voiceprint data with preset voiceprint data to determine whether the voiceprint data is matched with the preset voiceprint data or not. When the voiceprint data is matched with the preset voiceprint data, performing step 408; when the voiceprint data is not matched with the preset voiceprint data, performing step 416.

Step 408, reading keywords in a keyword list and matching the keywords with the voice information.

Step 410, determining whether the voice information includes the preset keywords in the keyword list or not. When the voice information includes the preset keywords, performing step 412; when the voice information does not include the preset keywords, performing step 414 or step 416.

Step 412, entering a secure system of the terminal.

Step 414, entering a common system of the terminal.

Step 416, outputting an alarm prompt when one or more unlocking operations fail. Specifically, the method of outputting an alarm prompt includes, but not limited to, locking the terminal, sending information to at least one related terminal, sending GPS (Global Position System) information to the at least one related terminal, etc.

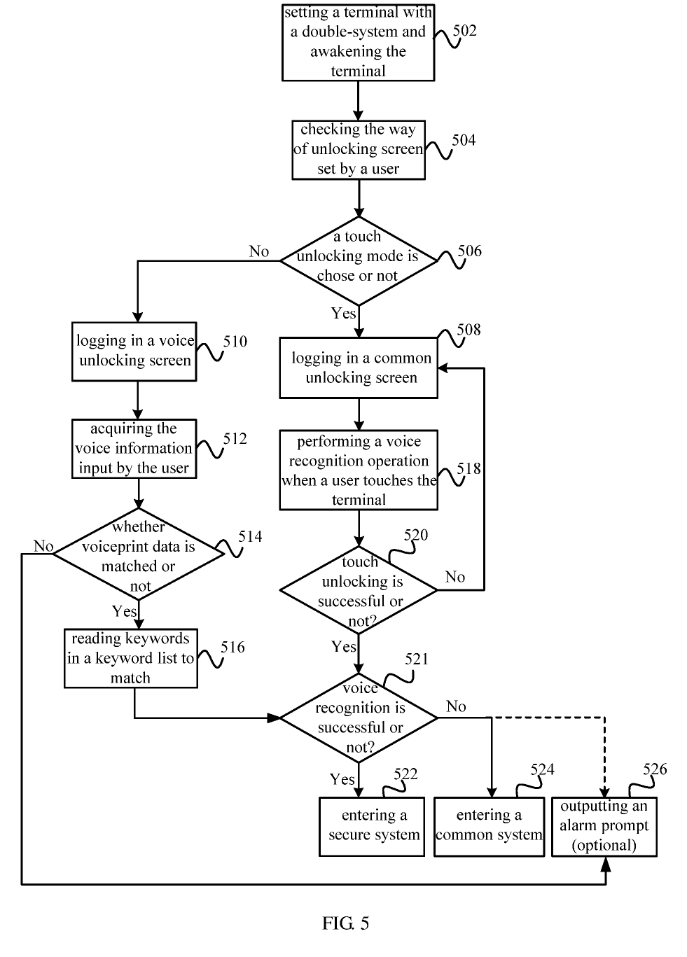

Referring to FIG. 5, FIG. 5 is a detailed flowchart of a screen interface unlocking method according to yet another embodiment of the present disclosure.

As shown in FIG. 5, the screen interface unlocking method provided by the embodiment of the present disclosure includes at least the following steps.

Step 502, setting a terminal with a double-system and awakening the terminal to activate the double-system.

Step 504, checking the way of unlocking screen set by a user. In particular, after activating the double-system, a prompt of “enter preset voice data” will pop up, and according to an unlocking mode chose by the user, different preset data needs to be input in the terminal, and the terminal displays different unlocking interfaces accordingly.

Step 506, determining whether a touch unlocking mode is chose or not to unlock a screen of the terminal. When the touch unlocking mode is chose, performing step 508; when the touch unlocking mode is not chose, performing step 510.

Step 508, entering a common unlocking screen.

Step 510, logging in a voice unlocking screen and input voice information input by a user.

Step 512, acquiring the voice information input by the user to unlock the screen.

Step 514, analyzing the voice information to generate voiceprint data and comparing the voiceprint data with preset voiceprint data to determine whether the voiceprint data is matched with the preset voiceprint data or not. When the voiceprint data is matched with the preset voiceprint data, performing step 516; when the voiceprint data is not matched with the preset voiceprint data, performing step 526.

Step 516, reading keywords in a keyword list and matching the keywords with the voice information.

Step 518, performing a voice recognition operation when a user touches a screen of the terminal.

Step 520, determining whether the screen of the terminal is unlocked or not by mans of the touch unlocking mode. When the screen of the terminal is unlocked by mans of the touch unlocking mode, performing step 521; when the screen of the terminal is not unlocked by mans of the touch unlocking mode, returning to the step 508. That is, determining whether a screen interface unlocking key input by the user is matched with a preset screen interface unlocking key or not. When the screen interface unlocking key is matched with the preset screen interface unlocking key, performing step 521; when the screen interface unlocking key isn't matched with the preset screen interface unlocking key, returning to the step 508. Specifically, when the screen of the terminal is not unlocked by mans of the touch unlocking mode, the process of voice recognition will not be performed and the terminal returns to the common unlocking interface; when the screen of the terminal is unlocked by mans of the touch unlocking mode, the terminal will further determines whether the voice recognition operation is successfully or not.

Step 521, determining whether the screen of the terminal is unlocked or not by mans of the voice recognition operation. When the screen of the terminal is unlocked by mans of the voice recognition operation, performing step 522; when the screen of the terminal is not unlocked by mans of the voice recognition operation, performing step 524 or step 526. That is, determining whether the voice recognition operation is matched with preset voice recognition data or not; when the voice recognition operation is matched with the preset voice recognition data, performing step 522; when the voice recognition operation is not matched with preset voice recognition data, performing step 524 or step 526.

Step 522, entering a secure system of the terminal.

Step 524, entering a common system of the terminal.

Step 526, outputting an alarm prompt when one or more unlocking operations fail. Specifically, the method of outputting an alarm prompt includes, but not limited to, locking the terminal, sending information to at least one related terminal, sending GPS (Global Position System) information to the at least one related terminal, etc.

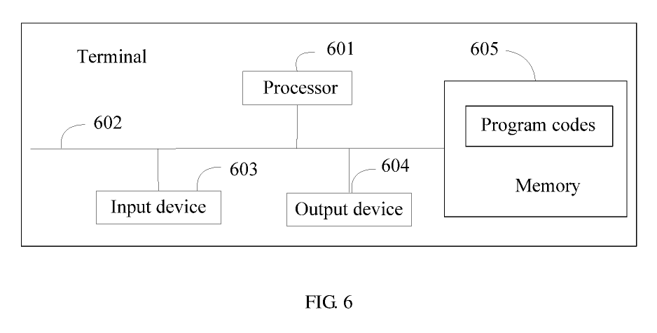

Referring to FIG. 6, FIG. 6 is a block diagram of a terminal according to an embodiment of the present disclosure.

As shown in FIG. 6, the terminal provided by this embodiment of the present disclosure can include: at least one input device 603, at least one output 604, at least one processor 601, such as CPU, a memory 605 and a at least one bus 602, the at least one processor 601 can combined with the screen interface unlocking device 200 as shown in FIG. 2.

The bus 602 is used to connect the at least one input device 603, the at least one output device 604, the at least one processor 601 and the memory 605.

Preferably, the input device 603 can be a touch panel of the terminal and is used to receive a screen interface unlocking key and a screen interface wake-up instruction; in addition, the input device 603 can also be a microphone of the terminal and is used to acquire voice information input by a user.

Preferably, the output device 604 can be a display screen or a player of the terminal and is used to prompt the user to input screen unlocking passwords corresponding to the way of touch unlocking operation.

Preferably, the memory 605 can be a high speed RAM (Random Access Memory) memory, and can also be a non-volatile memory, such as magnetic disk storage. The memory 605 may also be used to store a group of grogram codes or computer programs for implementing processes, and the input device 603, the output device 604 and the processor 601 can call and read the grogram codes or computer programs stored in the memory 605 to execute the following operations:

the input device 603 is configured for receiving a screen interface unlocking key input by a user and collecting voice information input by the user when receiving a screen interface wake-up instruction;

the processor 601 is configured for controlling the terminal to enter a first operating system when the screen interface unlocking key is matched with a preset target screen interface decryption key and the voice information is matched with preset target voice information;

the processor 601 is also configured for controlling the terminal to enter a second operating system when the screen interface unlocking key is matched with the preset target screen interface decryption key and the voice information is not matched with the preset target voice information; wherein, the security level of the first operating system is higher than the security level of the second operating system.

In an optional embodiment, the way of screen unlocking includes, but not limited to, a voice unlocking mode and a touch unlocking mode. When receiving the screen interface wake-up instruction, the input device 603 receives the screen interface unlocking key input by the user and acquires the voice information input by the user, which includes that in detail:

the processor 601 determines a present way of screen unlocking of the terminal when the input device 603 receives the screen interface wake-up instruction;

the output device 604 prompts the user to input screen unlocking passwords corresponding to the touch unlocking mode when the present way of screen unlocking is the touch unlocking mode;

the input device 603 receives the screen unlocking passwords input by the user and acquires the voice information input by the user; and

further includes:

the processor 601 matches the screen unlocking passwords with the preset target screen interface decryption key, and analyzes the voice information to generate voiceprint data, and matches the voiceprint data with preset voiceprint data;

the processor 601 determines that the voice information is matched with the preset target voice information when the voiceprint data is matched with the preset voiceprint data.

Further optional, after the processor 601 determines a present way of screen unlocking of the terminal, the input device 603, the output device 604 and the processor 601 can execute the following operations:

the input device 603 directly acquires the voice information input by the user and takes the voice information as the screen unlocking passwords when the present way of screen unlocking is the voice unlocking mode;

the processor 601 analyzes the voice information to generate corresponding voiceprint data, and matches the voiceprint data with the preset voiceprint data;

the processor 601 determines that the screen interface unlocking key is matched with the preset target screen interface unlocking key when the voiceprint data is matched with the preset voiceprint data;

the processor 601 determines whether the voice information includes preset keywords when the voiceprint data is matched with the preset voiceprint data; and

the processor 601 determines that the voice information is matched with the preset target voice information when the voice information includes the preset keywords.

Further optional, the processor 601 sets the target screen interface unlocking key, the preset voiceprint data and/or the preset keywords according to received setting commands.

In an optional embodiment, the output device 604 prompts the user that unlocking fails when the screen interface unlocking key is not matched with the preset target screen interface decryption key and the voice information is not matched with the preset target voice information; and

the output device 604 outputs an alarm prompt when the number of failed to unlock the screen reaches a preset number in succession.

In specific, the terminal such as a mobile phone provided in this embodiment can be used to implement some or all the steps of the embodiments in combination with FIGS. 1 and 3-5 in the present invention.

In combination with the drawings, above descriptions specify the technical solution of the present disclosure in detail, by means of the technical solution of the present invention, the concealment and security of a secure system in a double-system terminal can be increased to avoid leakage of privacy data in the secure system.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention.

1. A method for screen interface unlocking for a terminal, the terminal comprising a first operating system and a second operating system, wherein a security level of the first operating system is higher than a security level of the second operating system, the method comprising:
receiving a screen interface unlocking key input by a user and collecting voice information input by the user when the terminal receives a screen interface wake-up instruction;
controlling the terminal to enter the first operating system when the screen interface unlocking key matches a preset target screen interface decryption key and the voice information matches preset target voice information; and
controlling the terminal to enter the second operating system when the screen interface unlocking key matches the preset target screen interface decryption key and the voice information does not match the preset target voice information.

2. The method according to claim 1, wherein modes of screen unlocking comprising a voice unlocking mode and a touch unlocking mode, and receiving a screen interface unlocking key input by a user and collecting voice information input by the user when the terminal receives a screen interface wake-up instruction comprises:
judging a present mode of screen unlocking of the terminal when the terminal receives the screen interface wake-up instruction;
prompting the user to input screen unlocking passwords corresponding to the touch unlocking mode when the present mode of screen unlocking is the touch unlocking mode; and
receiving the screen unlocking passwords input by the user and acquiring the voice information input by the user; and wherein the method further comprises:
matching the screen unlocking passwords with the preset target screen interface decryption key, and analyzing the voice information to generate voiceprint data, and matching the voiceprint data with preset voiceprint data; and
determining that the voice information is matched with the preset target voice information when the voiceprint data is matched with the preset voiceprint data.

3. The method according to claim 2, further comprising:
directly acquiring the voice information input by the user and taking the voice information as the screen unlocking passwords when the present mode of screen unlocking is the voice unlocking mode;
analyzing the voice information to generate corresponding voiceprint data, and matching the voiceprint data with the preset voiceprint data;
determining that the screen interface unlocking key is matched with the preset target screen interface unlocking key when the voiceprint data is matched with the preset voiceprint data;
determining whether the voice information comprises preset keywords when the voiceprint data is matched with the preset voiceprint data; and
determining that the voice information is matched with the preset target voice information when the voice information comprises the preset keywords.

4. The method according to claim 3, further comprising:
setting at least one of the target screen interface unlocking key, the preset voiceprint data, and the preset keywords according to received setting commands.

5. The method according to claim 1, further comprising:
prompting the user that unlocking fails when the screen interface unlocking key is not matched with the preset target screen interface decryption key and the voice information is not matched with the preset target voice information; and
outputting an alarm prompt when the number of failed to unlock the screen reaches a preset number in succession.

6. A device for screen interface unlocking for a terminal, the terminal comprising a first operating system and a second operating system, wherein a security level of the first operating system is higher than a security level of the second operating system, the device comprising:
an acquiring unit, configured to receive a screen interface unlocking key input by a user and collecting voice information input by the user when the terminal receives a screen interface wake-up instruction;
a controlling unit, configured to:
control the terminal to enter the first operating system when the screen interface unlocking key matches a preset target screen interface decryption key and the voice information matches preset target voice information; and
control the terminal to enter the second operating system when the screen interface unlocking key matches the preset target screen interface decryption key and the voice information does not match the preset target voice information.

7. The device according to claim 6, wherein modes of screen unlocking comprising a voice unlocking mode and a touch unlocking mode, wherein the acquiring unit comprises:
a judging module configured to judge a present mode of screen unlocking of the terminal when the terminal receives the screen interface wake-up instruction;
a first prompting module configured to prompt the user to input screen unlocking passwords corresponding to the touch unlocking mode when the present mode of screen unlocking is the touch unlocking mode; and
an acquiring module configured to receive the screen unlocking passwords input by the user and acquiring the voice information input by the user; and wherein
the device further comprises:
a matching unit configured to match the screen unlocking passwords with the preset target screen interface decryption key, and to analyze the voice information to generate voiceprint data, and matching the voiceprint data with preset voiceprint data; and
a determining unit configured to determine that the voice information is matched with the preset target voice information when the voiceprint data is matched with the preset voiceprint data.

8. The device according to claim 7, wherein
the acquiring module is further configured to directly acquire the voice information input by the user and to take the voice information as the screen unlocking passwords when the present mode of screen unlocking is the voice unlocking mode;
the matching unit is further configured for analyzing the voice information to generate corresponding voiceprint data, and matching the voiceprint data with the preset voiceprint data;
the determining unit is further configured to:
determine that the screen interface unlocking key is matched with the preset target screen interface unlocking key when the voiceprint data is matched with the preset voiceprint data;
determine whether the voice information comprises preset keywords when the voiceprint data is matched with the preset voiceprint data; and
determining determine that the voice information is matched with the preset target voice information when the voice information comprises the preset keywords.

9. The device according to claim 8, further comprising a setting unit configured to set at least one of the target screen interface unlocking key, the preset voiceprint data, and the preset keywords according to received setting commands.

10. The device according to claim 6, further comprising:
a second prompting unit configured to prompt the user that unlocking fails when the screen interface unlocking key is not matched with the preset target screen interface decryption key and the voice information is not matched with the preset target voice information; and
an alarming unit configured to output an alarm prompt when the number of failed to unlock the screen reaches a preset number in succession.

11. A terminal, comprising:
a bus configured to connect the input device, the output device, the memory and the processor;
an inputting device configured to receive a screen interface unlocking key input by a user and collect voice information input by the user when receiving a screen interface wake-up instruction;
an outputting device;
a memory; and
a processor, wherein the memory includes program codes executable by the processor to:
control the terminal to enter a first operating system when the screen interface unlocking key matches a preset target screen interface decryption key and the voice information matches preset target voice information; and
control the terminal to enter a second operating system when the screen interface unlocking key matches the preset target screen interface decryption key and the voice information does not match the preset target voice, wherein a security level of the first operating system is higher than a security level of the second operating system.

12. The terminal according to claim 11, wherein modes of screen unlocking comprising a voice unlocking mode and a touch unlocking mode, and when receiving a screen interface wake-up instruction, the input device receives a screen interface unlocking key input by a user and acquire voice information input by the user, wherein
the processor judges a present mode of screen unlocking of the terminal when the input device receives the screen interface wake-up instruction;
the output device prompts the user to input screen unlocking passwords corresponding to the touch unlocking mode when the present mode of screen unlocking is the touch unlocking mode; and
the input device receives the screen unlocking passwords input by the user and acquires the voice information input by the user, wherein:
the processor matches the screen unlocking passwords with the preset target screen interface decryption key, and analyzes the voice information to generate voiceprint data, and matches the voiceprint data with preset voiceprint data; and
the processor determines that the voice information is matched with the preset target voice information when the voiceprint data is matched with the preset voiceprint data.

13. The terminal according to claim 12, wherein in response to the processor judging a present mode of screen unlocking of the terminal, the input device, the output device and the processor executes the following operations:
the input device directly acquires the voice information input by the user and takes the voice information as the screen unlocking passwords when the present mode of screen unlocking is the voice unlocking mode;
the processor analyzes the voice information to generate corresponding voiceprint data, and matches the voiceprint data with the preset voiceprint data;
the processor determines that the screen interface unlocking key is matched with the preset target screen interface unlocking key when the voiceprint data is matched with the preset voiceprint data;
the processor determines whether the voice information comprises preset keywords when the voiceprint data is matched with the preset voiceprint data; and
the processor determines that the voice information is matched with the preset target voice information when the voice information comprises the preset keywords.

14. The terminal according to claim 13, wherein
the processor sets at least one of the target screen interface unlocking key, the preset voiceprint data, and the preset keywords according to received setting commands.

15. The terminal according to claim 11, wherein
the output device prompts the user that unlocking fails when the screen interface unlocking key is not matched with the preset target screen interface decryption key and the voice information is not matched with the preset target voice information; and
the output device outputs an alarm prompt when the number of failed to unlock the screen reaches a preset number in succession.

16. The method according to claim 2, further comprising:
prompting the user that unlocking fails when the screen interface unlocking key is not matched with the preset target screen interface decryption key and the voice information is not matched with the preset target voice information; and
outputting an alarm prompt when the number of failed to unlock the screen reaches a preset number in succession.

17. The method according to claim 3, further comprising:
prompting the user that unlocking fails when the screen interface unlocking key is not matched with the preset target screen interface decryption key and the voice information is not matched with the preset target voice information; and
outputting an alarm prompt when the number of failed to unlock the screen reaches a preset number in succession.

18. The device according to claim 7, further comprising:
a second prompting unit configured to prompt the user that unlocking fails when the screen interface unlocking key is not matched with the preset target screen interface decryption key and the voice information is not matched with the preset target voice information; and
an alarming unit configured to output an alarm prompt when the number of failed to unlock the screen reaches a preset number in succession.

19. The terminal according to claim 12, wherein
the output device prompts the user that unlocking fails when the screen interface unlocking key is not matched with the preset target screen interface decryption key and the voice information is not matched with the preset target voice information; and
the output device outputs an alarm prompt when the number of failed to unlock the screen reaches a preset number in succession.

20. The terminal according to claim 13, wherein
the output device prompts the user that unlocking fails when the screen interface unlocking key is not matched with the preset target screen interface decryption key and the voice information is not matched with the preset target voice information; and
the output device outputs an alarm prompt when the number of failed to unlock the screen reaches a preset number in succession.
